(19) United States
(12) Patent Application Publication
(10) Pub. No.: US 2003/0065498 A1
(43) Pub. Date: Apr. 3, 2003

(54) Software tool for generation of scattering parameter models of N-port lumped element circuits for use in spice simulators

(76) Inventors: Karl J. Bois, Ft. Collins, CO (US); David W. Quint, Ft Collins, CO (US); Peter Shaw Moldauer, Wellington, CO (US)

Correspondence Address: HEWLETT-PACKARD COMPANY, Intellectual Property Administration, P.O. Box 272400, Fort Collins, CO, 80527-2400, US

(21) Appl. No.: 09/900,071

(22) Filed: Jul. 6, 2001

(51) Int. Cl. G06F 17/50

(52) U.S. Cl. 703/19

(57) ABSTRACT

A method and apparatus for simulating an electronic circuit having a plurality of ports uses a digital processor to identify signal transmission characteristics associated with each of the ports. A plurality of test frequencies are selected with which to measure frequency response of the electronic circuit at each of the ports. For each of the test frequencies, a signal characteristic is identified at each of the ports in response to a sequential application of each of said test frequencies to each port. Scattering parameters corresponding to each port are extracted for each frequency based on the signal characteristics. These scattering parameters are then transformed into a time domain representation of the electronic circuit.

### TECHNICAL FIELD

The present invention is related to circuit simulation and in particular, to a system and method of using scattering parameters to model lumped elements.

### BACKGROUND

As electronic circuit design has become increasing complicated, expensive and time consuming, computer-based circuit simulation has gained importance as a means of reliably testing designs of large circuits. Typically, a large circuit represents an aggregation of thousands of components, and it is difficult during the design stage of the circuit to predict how these components will influence one another during circuit operation. For example, reflected or time-delayed signals within a circuit may contribute to signal unintelligibility or instability, or may undesirably influence nearby electronic paths. This design problem is further enhanced when effects of other, external components are considered along with a sub-circuit being modeled. For example, when effects of adjacent high frequency transmission paths or surface mounts of an integrated circuit are considered together with the design of the integrated circuit, the resulting system model may be quite different than was the case for the integrated circuit alone. Moreover, as components are called upon to operate at faster and faster speeds, driven in large part by the speed of operation of newer digital systems, analysis of transient and high frequency conditions becomes increasingly critical to circuit reliability.

It is frequently desired to test large circuit designs before circuit prototypes are actually built, since prototype fabrication may be costly and time consuming; computer simulation of mathematical models only of the circuit design, before prototype fabrication, can lead to quick design changes while saving many thousands of dollars associated with such fabrication.

To this end, circuit simulation is frequently performed by software which operates on a mathematical model of a large circuit. A mathematical model of a circuit is frequently used, even if a circuit prototype is actually available, since high speed computers can quickly and efficiently predict circuit response at many different measurement points within the circuit, for example, at the ports of an integrated circuit, for many different input signal conditions. For large circuits designs, manual simulation can sometimes take far more time that computer-based simulation. Of course, the accuracy and speed of the computer-based model are very dependent upon the simulation tools used.

Many common computer simulators are variations of an early simulator tool, “SPICE,” (which stands for “simulation program with integrated circuit emphasis”). These programs typically operate by accepting circuit frequency response parameters, either directly from a computer aided design (“CAD”) package, a simulator (using discrete frequencies to directly measure frequency response of a circuit prototype), or another means. The simulator then is then typically used to, based upon these parameters, simulate special signal conditions for the circuit which are usually not discrete frequencies, i.e., to predict transient responses and the like. The computer-based simulators typically use numbers which represent test input signals, e.g., initial voltages, currents and frequencies. The simulators then usually conduct a time-based analysis of response to the input signal conditions at the different measurement points of the circuit.

In addition to circuit simulation of discrete components such as transistors, resistors and capacitors, increasing clock rates mandates consideration of signal paths, e.g., metallization layers of integrated circuits, connections between and among integrated circuits, circuit board connections, etc. From a system perspective, these signal path covers the range of die to package to printed circuit board to package and finally back to die transmission path. Traditionally, simulators have required that the appropriate electrical parameters be specified in a portable format, typically as a lumped element. That is, lumped element models have been used to characterize physical substructures. In these models, and with reference to FIG. 1, inductance (L) 105 and capacitance (C) 106 determine the wave velocity of the signal path and resistance (R) 104 is used to represent the combined trace and ground resistance. Not shown is resistance G, paralleling capacitance 106, and representing dielectric losses that are typically small enough to be ignored. Note that all quantities are typically length normalized, i.e., are expressed in terms of units per unit of length.

The single line model may be expanded to accommodate multiple signal paths that are sufficiently close to require consideration of intersignal effects. These effects may result from capacitive Cₘ 201 and/or inductive coupling Lₘ 202 between nearby signal lines as shown in FIG. 2. Naturally, as the architecture of a device becomes more complicated, each signal path will affect and be affected by a larger number of nearby signal paths. For example, in FIG. 3A, signal lines 301, 302, 303 and 304 are embedded in insulating material 305 constituting a dielectric between the signal lines, upper and lower ground planes 306 and 307 and power plane 308. Signal lines 301-304 may be in the form or metalization layers of an integrated circuit, wiring on a printed circuit board, or any other form of conductor forming a signal transmission line. In the case of an integrated circuit, insulating material 305 may be a silicon substrate.

In addition to capacitive coupling between and among these elements represented by electric field lines 309, each signal line also inductively coupled to the others. Thus, as shown in FIG. 3B, each signal line (including the power plane) may be modeled as a lumped element including a series resistor and inductor, a parasitic capacitor to ground, one or more parasitic capacitors coupling the signal line to other signal lines, and an inductive component or components Lₘ coupling the signal line to the other lines.

The schematic diagram of FIG. 3B represents a simplified circuit equivalent of the physical structure shown in FIG. 3A and in particular, corresponding to signal lines 301 and 302, power plane 308, and signal lines 303 and 304. The conductors forming the signals lines may be represented by a series self resistance Rₙ. and inductance Lₙ, a parasitic self capacitance (i.e., capacitive coupling to ground) Cₙ, a mutual capacitance to other signal lines collectively represented by Cₘ, and a mutual inductive coupling parameter Lₘ collectively representing inductive coupling to other conductors. For brevity and purposes of illustration only, the mutual capacitance and inductance to the neighboring lines are shown. Modeling of the two-dimensional physical architecture may be provided by various electromagnetic solvers such as Ansoft SI 2D and MIT's FCAP.

Those skilled in the art will recognize that, with increasing signal frequency, distributed parameters may not be lumped into a single circuit equivalent, but must be distributed into multiple circuit equivalents over the length of the signal path. Otherwise, the lumped parameter equivalent would have a 3 db break frequency of

$${f}_{c} = \frac{1}{l \sqrt{L C}}$$

so that length l must be small enough to avoid filtering out the input waveform. That is, in order to model a section of the line, the user must calculate the largest permissible subsection length and concatenate a plurality of such segments to form the desired line length. For example, referring to FIG. 4, these distributed parameters are lumped into a number n of concatenated lumped parameter circuit equivalents 401a, 401b . . . 401n for purposes of simulation and analysis. As is appreciated by those skilled in the art, since the frequency content of the input signal increases with incremental chip designs, this therefore drives up the complexity of the simulated circuit.

Concatenation of multiple lumped parameter circuit equivalents also brings about circuit simulator convergence issues. Although various techniques may be employed to reach convergence to a solution (e.g., modification of the value of a MU parameter used by circuit simulators such as SPICE), there is no guarantee that the simulator will converge to an accurate solution.

Some simulators employing “direct convolution” operate directly on the frequency response parameters by multiplying them with input test signals which have been converted to the frequency domain (including both instantaneous inputs as well as historical inputs, to thereby account for time-delays within the circuit). By properly selecting test frequencies, one obtains information to predict an entire range of operation of a digital device (commonly extending from near zero hertz to several gigahertz). Ideally, a set of frequency responses provides a complete set of information from which to model circuit performance for any given input frequency or condition. This information is then processed to determine the frequency response parameters which, generally, are in the form of an impedance matrix or an admittance matrix; it is also sometimes desired to use a “scattering” matrix, which is defined by the relation:

$$S = \frac{( Q - Y ) {( Q + Y )}^{- 1}}{{Z}_{0}}$$

where “Q” is an identity matrix, “Y” is an admittance matrix for the circuit, and Z₀ is a reference impedance. Scattering parameters (or “S-parameters”) are sometimes preferred, because the S-parameters of passive devices will always have an absolute value less than 1, dramatically increasing the stability of typical analysis based upon them. The computer-based simulator may then operate by using an inverse fast fourier transform (“IFFT”) to convert the parameters to the time domain, and by applying time-intensive direct convolution of the time domain parameters to the test input signals of interest, to yield predicted circuit behavior. Unfortunately, use of the IFFT requires that the frequency response parameters represent evenly spaced frequencies, e.g., 0, 5, 10, 15 kilohertz, etc.

While generally acceptable for many circuits, direct convolution processes can sometimes take many hours to run for complicated circuits, because of the number of iterations that need to be performed. For example, since direct convolution methods typically convert time history of the test input signals, at each time increment, to the frequency domain for multiplication with frequency response parameters, which requires a great deal of numerical processing for each time step. Furthermore, the requirement that the parameters represent only evenly spaced test frequencies implies that frequency response of the circuit must be measured for an inordinate number of test frequencies, since it is typically desired to ascertain frequency response for frequency change of only a few hertz, yet also cover the circuit's entire operating range. Consequently, use of direct convolution and an IFFT can be quite time consuming where testing is desired over a very large frequency range. There is a definite need for a circuit simulator which can accommodate testing over a very wide frequency range, preferably using parameters not measured at evenly spaced frequencies, and that can perform processing very quickly, even for large circuits.

Other common simulator designs use alternatives to direct convolution known as “macromodeling” or “recursive convolution.” “Macromodeling” is performed using the impedance, admittance or S(cattering)-parameters to build and fit a system transfer function that describes response at each measurement point in dependence upon inputs signals to the circuit; in other words, a formula is computed from the frequency response parameters, and the parameters are not directly used themselves in the actual simulation. The transfer function typically is estimated by computing a rational polynomial, based on the frequency response parameters, and applying an iterative best fit analysis. The resulting polynomials are then implemented as equivalent circuits, and the circuit under consideration is processed by time-stepped analysis using a simulator, for example, using a “SPICE” simulator. Alternatively, simulators employing “recursive convolution” typically take an inverse Laplace transform of the fitted polynomials, to obtain time-domain relations, and use processing shortcuts to convolve the time-domain relations with inputs to the circuit.

For example, U.S. Pat. No. 5,946,482 entitled “METHOD AND APPARATUS FOR USING PARAMETERS TO SIMULATE AN ELECTRONIC CIRCUIT” issued Aug. 31, 1999, to Barford, et al., the disclosure of which is hereby incorporated herein by reference in its entirety, describes a method and apparatus for using frequency domain data, such as S-parameters, in a time-based simulator. S-parameters are either input to the simulator, or are empirically measured, at selected frequencies. Preferably, the selected frequencies are related to one another by a logarithmic scale, providing for determination of a system transfer function which is accurate across a very wide range of frequencies, from near zero hertz, to frequencies on the order of a hundred gigahertz. The transfer function preferably takes the form of a fitted polynomial, obtained using FDSI techniques. In addition, recursive convolution may be employed to operate in the time domain on inverse Laplace Transforms of the fitted transfer function and time-domain simulator test signals. The patent further describes circuit modeling and simulation which is accurate across a wide frequency range, which is stable for transfer functions of high order, and which is quickly and efficiently performed for large circuits.

U.S. Pat. No. 5,321,364 entitled “NETWORK ANALYZER” issued Jun. 14, 1994, to Nukiyama, et al., the disclosure of which is hereby incorporated herein by reference in its entirety, describes a network analyzer for determining the type and element values of a hypothetical lossless matching circuit for a device under test (DUT) and for computing and displaying S parameters of the DUT in combination with the matching circuit.

While use of S-parameters simplifies modeling and simulation of signal lines that would otherwise require discrete time based analysis using a SPICE or similar simulator, derivation of the S-parameters has been difficult. In particular, a user would need to perform a complicated analysis of the system to calculate the pertinent S-parameters. While this method was not prohibitive in connection with simulation of a single transmission line, it is complicated and difficult to perform for multiple signal line arrangements.

### SUMMARY OF THE INVENTION

The present invention is directed to a system and method in which scattering parameters of a lumped element equivalent model for a transmission line structure are calculated using a circuit simulator. Each port (i.e., an input or output node of an electrical circuit) is “fed” by an AC signal source in series with a resistor of value Z₀; the remaining ports are terminated with respective resistances of value Z₀. Preferably, an excitation signal of two volts is simulated at each port and the resultant voltages present at each of the nodes is calculated by the circuit simulator. Using this protocol, the “reflected” s-parameter of the driving port is set equal to the calculated voltage at the port minus one, while the incident terms represented by the off-diagonal terms of the s-matrix are equal to the value of the voltage calculated at the respective node The voltage values at each port constitute respective scattering parameters. Thus, in turn, each of the ports is excited by the AC signal source until a complete matrix of s-parameters is obtained at each signal frequency of interest.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a schematic diagram of a transmission line represented as a set of lumped parameters;

FIG. 2 is a schematic diagram of a pair of transmission lines represented as respective sets of lumped parameters;

FIG. 3A is a cross-sectional view of the structure of signal lines formed on a multilayer substrate;

FIG. 3B is a schematic diagram modeling the structure of FIG. 3A;

FIG. 4 is a schematic diagram of a transmission line represented as multiple sets of lumped parameters distributed over a length of the transmission line;

FIGS. 5A-5D are schematic diagrams of simulated excitation and voltage sampling points for identifying scattering parameters of a 4-port device;

FIG. 5E is a four-by-four S-matrix representing the s-parameters determined using the excitation arrangement of FIGS. 5A-5D;

FIG. 6 is a graphical user interface for a system for modeling an electronic device using s-parameters;

FIG. 7 is a graphical user interface of a system used to generate s-parameters of a simulated circuit;

FIG. 8 is a graphical user interface of a system used to specify subcircuit labels of a six port circuit;

FIG. 9 is a graphical user interface of a system upon completion of s-parameters and a simulator output file; and

FIGS. 10A and 10B are a flow chart detailing a method of simulating a circuit according an embodiment of the invention.

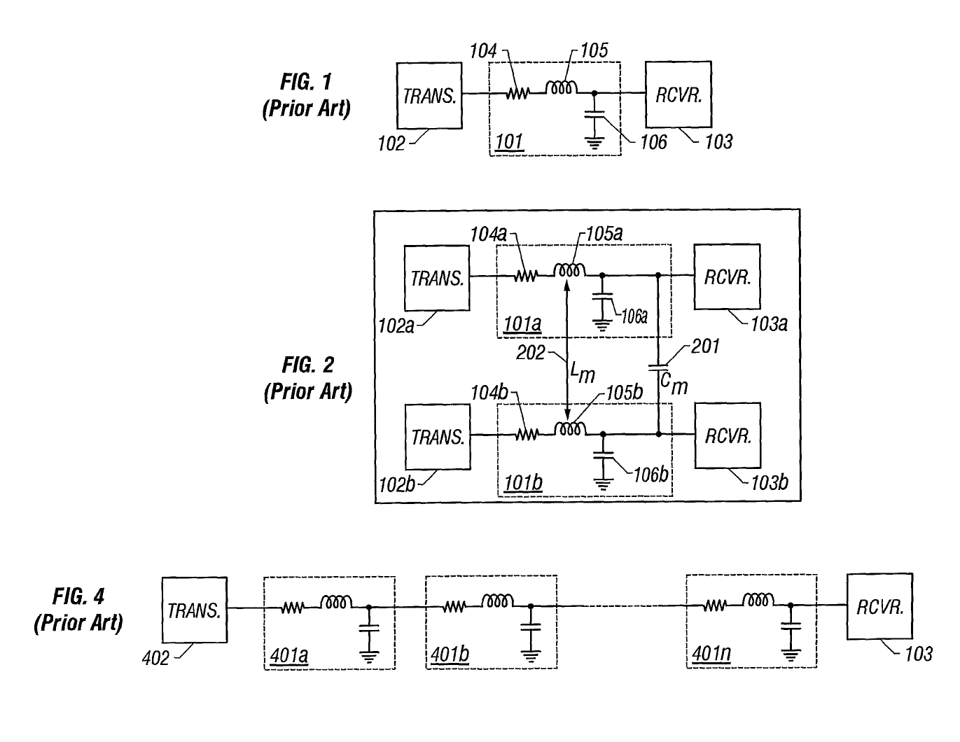

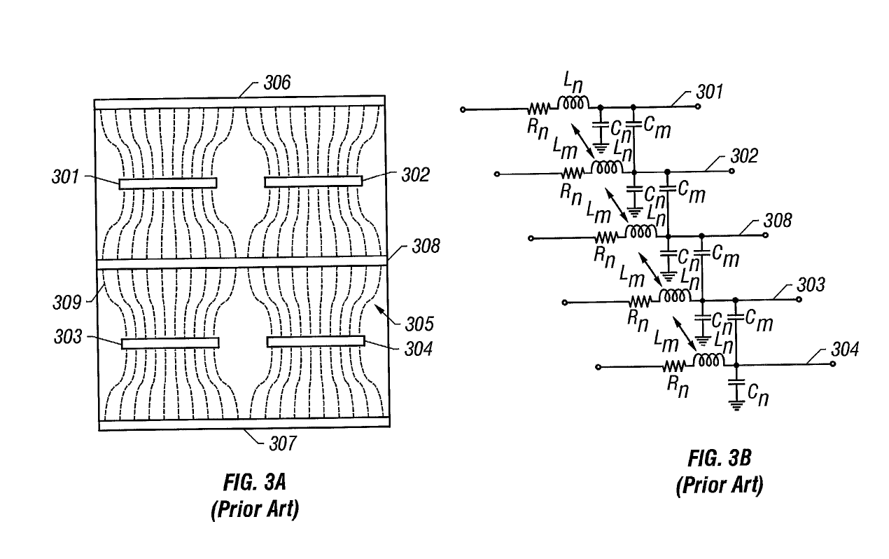

### DETAILED DESCRIPTION

The present invention permits the automated conversion of lumped element equivalent models of transmission line structures into an N-port scattering parameter (s-parameters) equivalent. The transmission line structures are typically produced by a 2-dimensional field solvers such as Ansolft SI 2D™. The resulting S-parameter equivalent model is then used in a circuit simulator such as SPICE. Use of the S-parameter equivalent removes the need to manually write simulator files that are otherwise required to measure the S-parameters of the lumped element equivalent model and concatenate results in the proper order to produce CITI files.

The S-parameters are formed by simulating an excitation signal at each port of a multi-port device. Note that the multi-port device may represent, for example, electrically isolated circuits including signal lines that may affect each other due to parasitic capacitive and/or inductive coupling between and/or among the lines. For example, an eight-bit bus connecting a bank of eight driver circuits to a bank of eight receivers may be modeled and treated as a sixteen-port device.

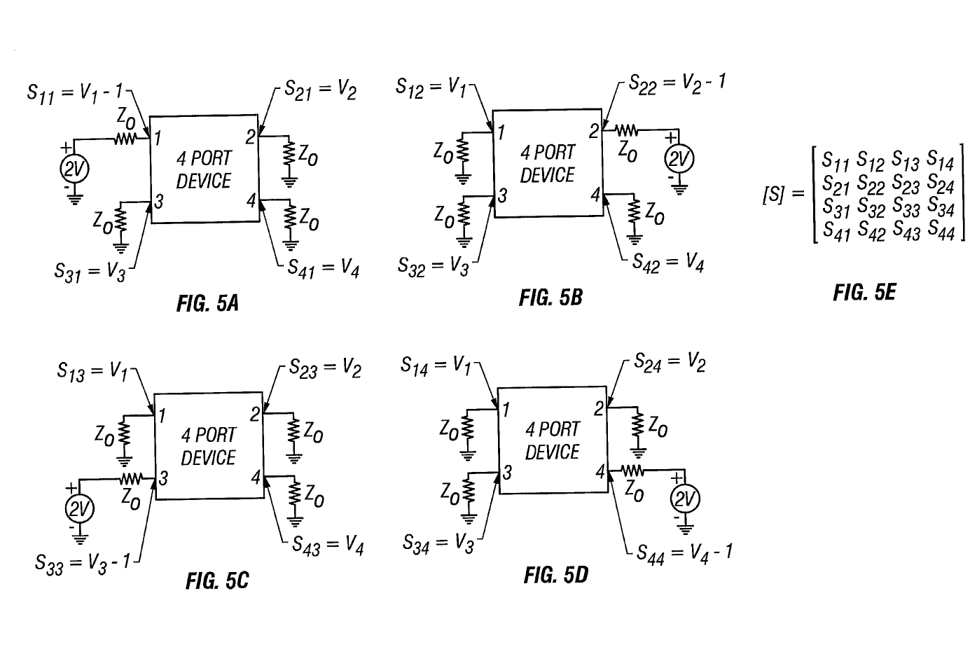

For purposes of illustration, identification of the S-parameter equivalent model of a four-port device is presented with reference to FIGS. 5A-5D and the resultant S-parameter matrix of FIG. 5E. This might represent, for example, a differential pair of signal lines. As shown in FIG. 5A, an appropriate sinusoidal or other AC driving signal is applied, using an appropriate circuit simulator such as SPICE, through a resistance Z₀ to one port of the device, i.e., a driven port. Preferably, to simplify calculation, the driving signal should have an amplitude of 2 volts peak or 4 volts peak-to-peak or RMS, depending on the voltage measurement scheme and type of signal applied. As the frequency of the driving signal is “swept” through desired increments, the voltage at the remaining “sampling” ports is measured, i.e., calculated by the simulator. The voltage at these sampling ports then represents the respective S-parameter value; a value of one volt is subtracted from the calculated voltage appearing at the driven port to obtain the “reflected” signal voltage appearing at the driven port. Note that all voltages may be real or complex values, i.e., expressed as ax+bj.

In the case of the present illustration, a 2-volt sinusoidal signal is applied, via simulation, through a resistance Z₀ to port 1, while ports 2-4 are terminated with the same resistance value of Z₀ ohms. The value “1” is subtracted from the calculated signal voltage at port 1 to arrive at the corresponding s-parameter value S₁₁ (FIG. 5E) representing the reflected signal at port 1. The voltages at ports 2, 3 and 4 represent s-parameters values S₂₁, S₃₁ and S₄₁, respectively. The frequency of the driving signal may be changed to include a set of discrete driving frequencies up to some Fₘₐₓ. Fₘₐₓ may be specified directly by a user or may be calculated based on some other criteria, for example, twice, 2.2 or 2.5 times the inverse of the minimum signal rise time of the simulated device, i.e. at least twice the maximum frequency content of the intended input wave. The procedure is then repeated for each of the ports. Thus, as shown in FIG. 5B, port 2 is driven by the same set of signals and signal frequencies, S₂₂ in each case being set to equal to the value of the voltage measured (e.g. calculated by the circuit simulator) at port 2 minus 1. The voltages at ports 1, 3 and 4 represent the values of S₁₂, S₃₂ and S₄₂, respectively. This process is then repeated, the driving signal be applied to ports 3 and 4 to obtain respective set of values for S₁₃, S₂₃, S₃₃ and S₄₃; and S₁₄, S₂₄, S₃₄ and S₄₄ for each of the driving signal frequencies. The resulting set of s-parameter matrices (see FIG. 5E) represent S-parameters in the frequency domain and may then be transformed using, for example, an inverse fast Fourier transform (IFFT) to obtain a time domain analysis.

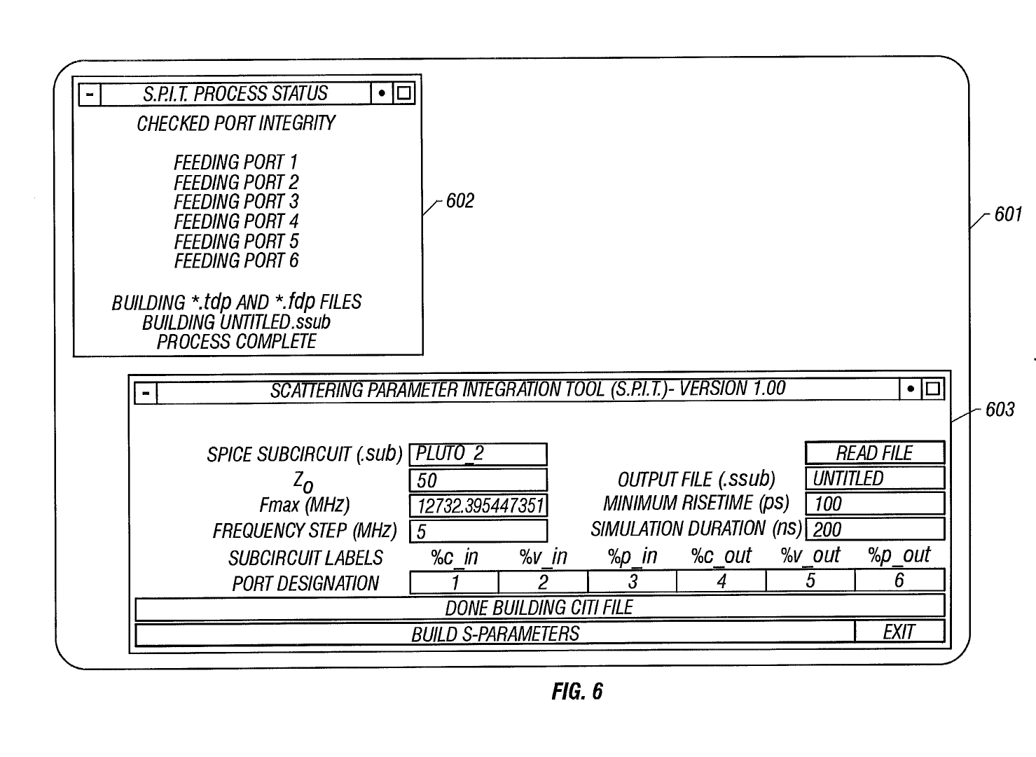

FIG. 6 is a diagram of a graphical user interface (GUI) developed to calculate S-parameters of a device. SPIT (S-Parameter Integration Tool) written in Perl/Tk. The tool calculates the S-parameters and produces the necessary files for use with a circuit simulator such as SPICE. These files include both time domain (“.tdp”) and frequency domain (“.fdp”) data. Window 602 presents the SPIT Process Status as each port of, in this case, a six port device, is driven by a set of signals. Window 603 includes parameters and values used by the SPIT process, including the name of the SPICE file describing the device, the line impedance of the ports, the maximum signal frequency used to drive each port and the step used to increment from DC to the maximum frequency, the name of the output file, the minimum rise time (ps) of the driving signal, and the simulation duration time. Window 603 also includes the user designated names for each of the ports, a status line and various control buttons. SPIT removes the burden of having to manually write the circuit simulator files that are produced to measure the S-parameters of the lumped element equivalent model and concatenates results in the proper order to produce a CITI file for the circuit simulator.

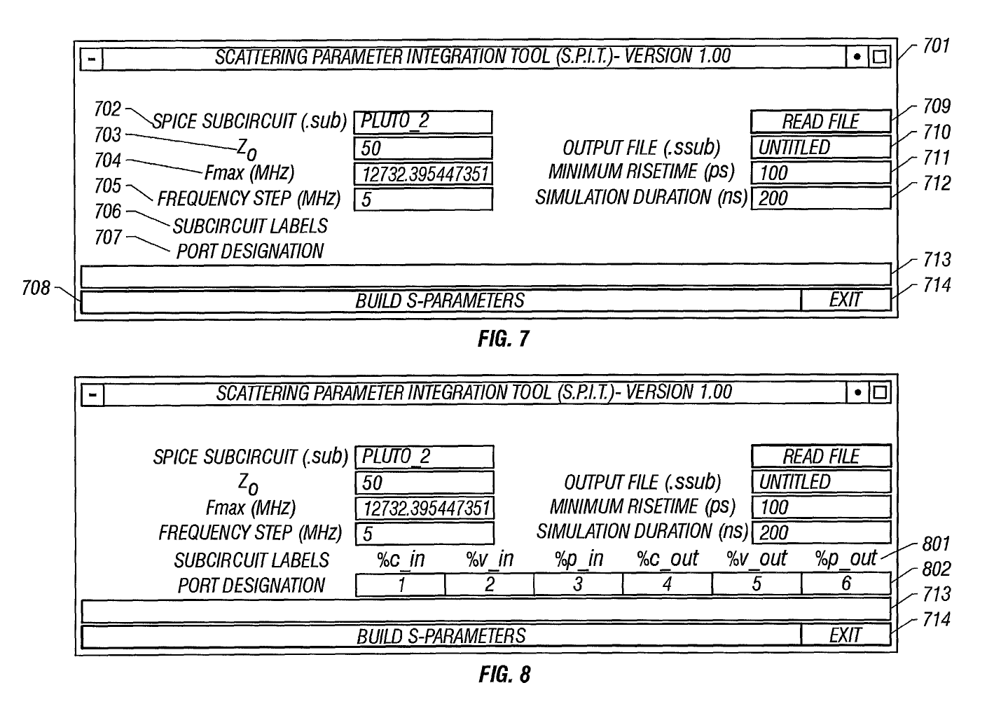

FIG. 7 is a portion of the SPIT GUI 701. Initially, the user must enter the name of the SPICE subcircuit as prompted at area 702; in this case “pluto_{—}2”. The user must also provide a value for the port terminating resistance value if other than some default value, in this case 50 ohms resistive at shown in area 703. The maximum signal frequency to be applied to each port is entered in area 704. Alternatively, the user may indicate a minimum signal risetime in picosecond in area 711 and the tool will calculate the corresponding maximum signal component frequency. For example, a minimum risetime of 100 picoseconds equates to a minimum frequency component of interest of 12.732 Ghz displayed in area 704. The frequency step size is specified in area 705, in this case a step size of 5 MHz will be used during the simulation, the signal frequency varying from DC to 12732 MHz in 5 MHz increments.

Button 709 allows the user to initiate reading of the input files specified in area 702 by the tool. The user specified output file is displayed in area 710, the minimum signal rise time in area 711, and the simulation duration in area 712. Area 713 provides status and message information to the user. Button 708 initiates S-parameter building, while 714 allows the user to exit the tool.

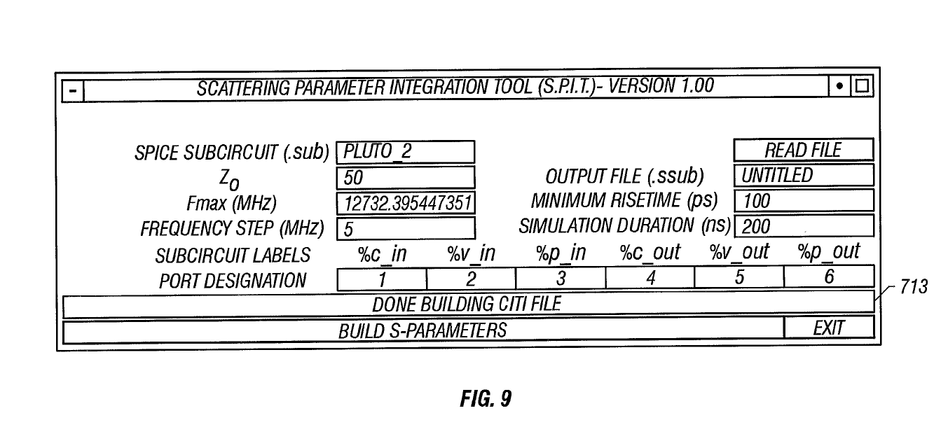

With reference to FIG. 8, the user may specify names 801 to be associated with each of the respective ports 802 of the device. With reference to FIG. 9, completion of S-parameter building is signified by window 713, indicating that the corresponding CITI file has been built.

Once a suitable transfer function has been fitted to the measured S-parameters, then the fitted transfer function is utilized to perform simulation, either via its implementation as an equivalent circuit and macromodeling using a simulator such as SPICE, or via use of recursive convolution alone. Preferably, recursive convolution is utilized to at least model a sub-circuit, with macromodeling being utilized thereafter as appropriate, based upon the transient response of a sub-circuit which has been simulated in the time-domain.

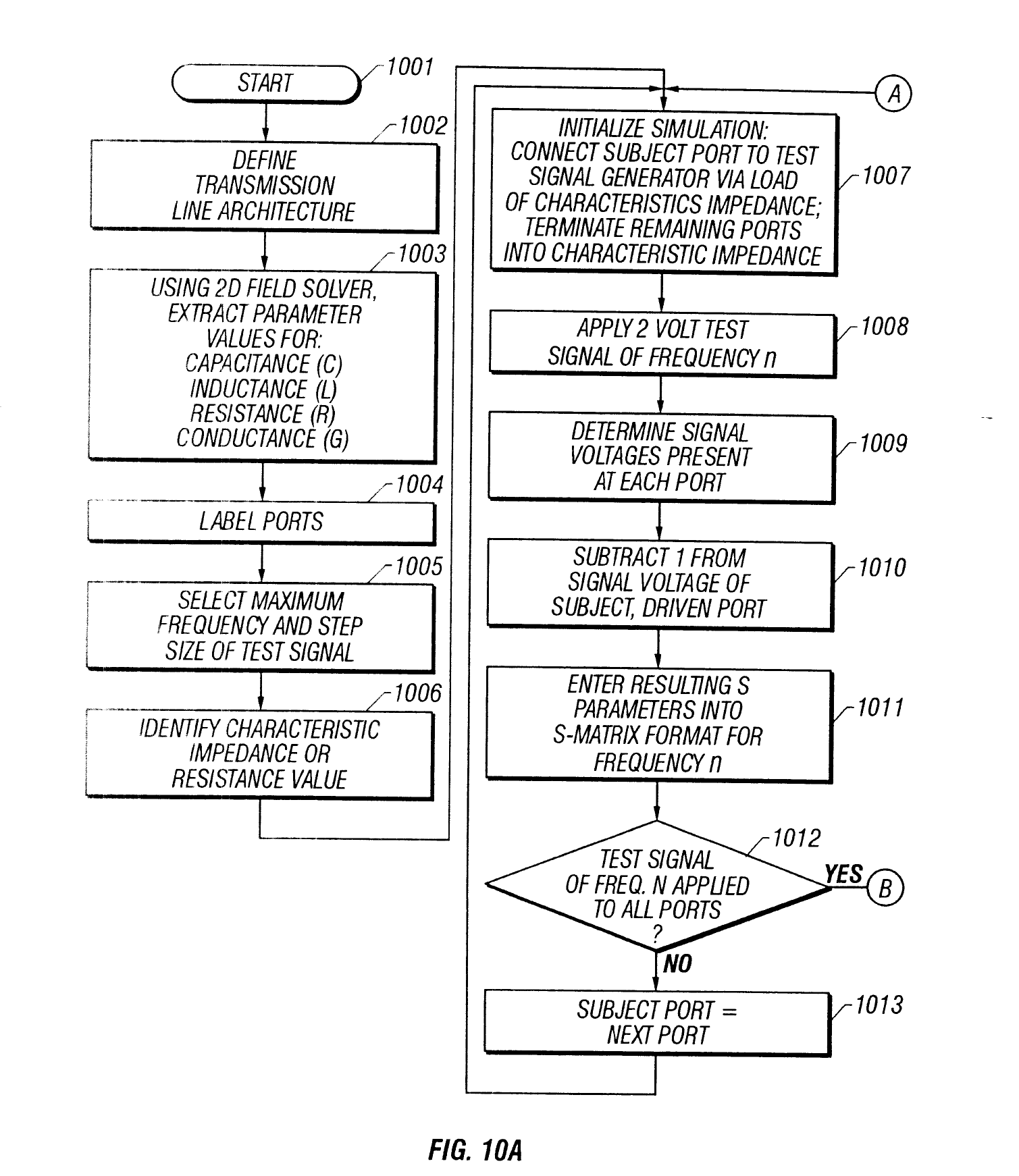

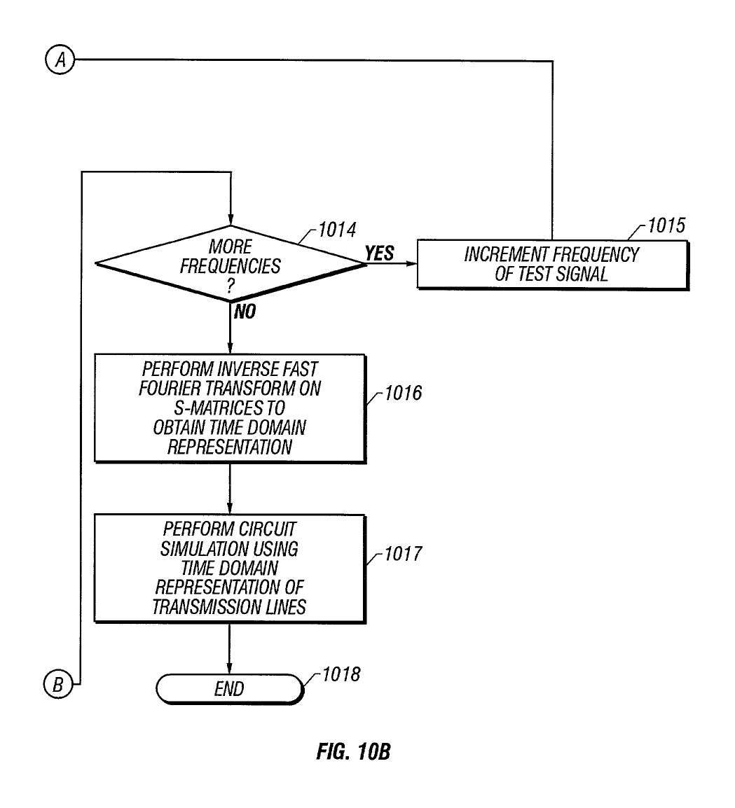

A method according to the invention is depicted in the flow diagram of FIGS. 10A and 10B. The method begins at terminal 1001, and at step 1002 a definition is provided of the physical structure of the circuit to be modeled and, in particular, the signal or transmission lines of the circuit. The definition should be in a form and format compatible with an appropriate two-dimensional field solver such as Ansoft SI 2D™. The two-dimensional field solver is used at step 1003 to extract parameter values including, for example, capacitance, inductance, resistance and conductance parameter values associated with each of the lines. These parameters may also include mutual inductive and capacitive coupling between and among the lines. With the ports identified as the terminal ends of each line, the user may label each port at step 1004 and, at step 1005, select both the maximum test signal frequency and frequency step size. Typically, the test signal with start at a D.C. value of 2 volts and increase through testing up to and including the desired maximum frequency. As previously described, instead of specifying the maximum frequency, the user may instead specify a minimum rise time of the test signal which will be used to calculate the maximum frequency to be used. At step 1006 the user can specify a characteristic impedance, typically a purely resistive load, to be used to terminate ports and through which the test signal is applied to a particular “subject port.”

At step 1007 the simulation is initialized, the outer loop stepping through each of the test signal frequencies, the inner loop sequentially applying the test signal to each port while monitoring the predicted signal at the remaining ports and at the port being driven. Thus, at step 1007, the simulator is configured to apply the test signal to a first one of the ports through a series resistance having a resistance value equal to the selected characteristic impedance; the remaining (no driven) ports are terminated into the characteristic impedance. The characteristic impedance may represent the output impedance of the driver device feeding a particular port or the input impedance of a receiver connected to receive a signal from a port.

At step 1008 the system simulates application of the test signal to the subject driven port (i.e., the port at which the test signal is applied) and, at step 1009 calculates the resultant signal voltage at all ports. Step 1010 calculates the reflected signal component at the driven port by subtract 1 volt from the calculated signal voltage value at that port. The resulting S values are then stored in a matrix format at step 1011 for each signal frequency.

The bottom of the inner loop is implemented by decision 1012 which checks to see if measurements have been made for a complete set of ports, i.e., with each port having been driven by the test signal of a given frequency, thereby completing the S-matrix for that frequency. If not all ports have been driven by the test signal, then the designation of the port to be driven during a next iteration is incremented at step 1013, and processing continues back at step 1007 to initiate a new set of measurements. Otherwise, if all ports have been driven so that the S-matrix is complete, then a check is performed at decision to see if more frequencies are to be tested. If so, then the frequency of the test signal is incremented at step 11015 and processing continues back at step 1007.

Once all S parameters and S-matrices for the desired frequencies are computed, the results are transformed into a time domain representation of the circuit by performing an inverse discrete fast Fourier transform at step 1016. Those skilled in the art will recognize that other transforms may be used including, for example, a reverse discrete cosine transform. The time domain representation of the circuit may then be used at step 1017 to perform circuit simulations. These simulations may identify, for example, maximum circuit operating speeds, timing and contention issues, signal degradation issues, requirements for signal repeaters and amplifiers, etc.

The subject method may be supported by various suitable processing platforms used in the art to conduct circuit simulation and testing including, for example, processor based systems such as a typical work station configurations.

As will be recognized by those skilled in the art, the present technique avoid the problem of concatenating a large number of simulation subcircuits using a lumped parameter approach. Not only does concatenation often cause the simulator to “crash”, but even when the simulation is completed, there may be a failure to converge to a solution. The proposed S-parameter approach is a more robust technique. Further, by automating the generation of the S-parameters, an appropriate number of frequency samples may be included without requiring tedious manual calculation.

What is claimed is:

1. A method of simulating an electronic circuit, the electronic circuit having a plurality of ports, said method comprising:
identifying signal transmission characteristics associated with each of said ports;
selecting a plurality of test frequencies with which to measure frequency response of the electronic circuit at each of the ports;
identifying, for each of said test frequencies, a signal characteristic at each of said ports in response to an application of each of said test frequencies at each of said ports;
extracting scattering parameters corresponding to each of the ports, for each test frequency, based on said signal characteristics; and
transforming said scattering parameters into a time domain representation of said electronic circuit.

2. The method according to claim 1 wherein said extracting step includes forming, for each of said test frequencies, a scattering parameter matrix based on said signal characteristics.

3. The method according to claim 1 wherein said signal characteristics comprise signal voltages at respective ones of said ports.

4. The method according to claim 1 wherein said identifying step includes simulating an application of test signals corresponding to each of said test frequencies at each of said ports, wherein said test signals are applied to each of said ports one at a time through a predetermined characteristic impedance and remaining ones of said ports are terminated in said characteristic impedance.

5. The method according to claim 4 wherein said step of extracting includes determining a signal voltage at each of said ports in response to said simulating step and subtracting a predetermined value from a signal voltages at a port at which said test signals are applied to provide a scattering parameter representing reflective signal parameter values of said test signals.

6. The method according to claim 1 wherein said step of identifying signal transmission characteristics associated with each of said ports includes a step of using an n-dimensional field solver to extract parameter values.

7. The method according to claim 6 wherein said n-dimensional field solver comprises a two-dimensional field solver providing distributed component parameter values corresponding to said ports, said component parameter values including one or more of circuit capacitance, inductance, resistance and conductance.

8. The method according to claim 1 further comprising a step of simulating said electronic circuit using said time domain representation of said electronic circuit.

9. A method of simulating an electronic circuit, said method utilizing a digital processor and comprising:
identifying a plurality of signal transmission paths;
determining distributed electrical parameters associated with each of said transmission path;
associating port designations with terminal ends of each of said ports;
determining a signal voltage at each of said ports resulting from a sequential application of a test signal to each of said ports, one at a time, said test signal applied through a characteristic impedance while others of said ports are terminated in said characteristic impedance;
extracting scattering parameters corresponding to each of the ports based on said signal voltages determined at each of said ports; and
transforming said scattering parameters into a time domain representation of said electronic circuit.

10. The method of claim 9 wherein said test signal includes a plurality of non-overlapping discrete signal frequencies sequentially applied to said ports.

11. The method according to claim 10 wherein said extracting step includes forming, for each of said discrete signal frequencies, a scattering parameter matrix based on respective sets of said signal voltages.

12. The method according to claim 9 wherein said step of determining a signal voltage at each of said ports includes simulating said plurality of signal paths.

13. The method according to claim 9 wherein said electronic circuit comprises an integrated circuit and said signal paths comprise metalization layers formed on said integrated circuit.

14. The method according to claim 9 wherein said electronic circuit comprises a printed circuit board and said signal paths comprise transmission lines formed on said printed circuit board.

15. The method according to claim 9 wherein said step of determining distributed electrical parameters associated with each of said transmission path includes a step of using a two-dimensional field solver to extract parameter values of said distributed electrical parameters.

16. The method according to claim 15 wherein said distributed electrical parameters include at least one of a circuit capacitance, inductance, resistance and conductance associated with each of said signal transmission paths.

17. The method according to claim 9 further comprising a step of simulating said electronic circuit using said time domain representation of said electronic circuit.

18. An apparatus comprising code for controlling a machine to simulate a circuit based on simulation parameters, and machine-readable media on which the code is stored, the simulation parameters representing frequency-dependent response at each of a plurality of measurement ports, said code directing a machine to:
identify signal transmission characteristics associated with each of said measurement ports;
identify a plurality of test frequencies with which to measure frequency response of the electronic circuit at each of the measurement ports;
predicting, for each of said test frequencies, a signal characteristic at each of said measurement ports in response to an application of each of said test frequencies at each of said measurement ports;
extracting scattering parameters corresponding to each of said measurement ports, for each test frequency, based on said signal characteristics and
transforming said scattering parameters into a time domain representation of said electronic circuit to provide said simulation parameters.

19. The apparatus according to claim 18 wherein the code directs the machine to form, for each of said test frequencies, a scattering parameter matrix based on said signal characteristics.

20. The apparatus according to claim 18 wherein the code directs the machine to simulate an application of test signals corresponding to each of said test frequencies at each of said measurement ports, wherein said test signals are applied to each of said measurement ports one at a time through a predetermined characteristic impedance and remaining ones of said ports are terminated in said characteristic impedance.

21. The apparatus according to claim 18 wherein the code directs the machine to execute a two-dimensional field solver to extract parameter values corresponding to said signal transmission characteristics associated with each of said measurement ports.
